(19) United States
(12) Patent Application Publication
(10) Pub. No.: US 2021/0205667 A1
(43) Pub. Date: Jul. 8, 2021

(54) TREE-MOUNTABLE CLIMBING STICK DEVICES AND METHODS OF USE

(71) Applicant: Matthew Garis, Enid, OK (US)

(72) Inventor: Matthew Garis, Enid, OK (US)

(21) Appl. No.: 17/110,003

(22) Filed: Dec. 2, 2020

Related U.S. Application Data
(60) Provisional application No. 62/943,078, filed on Dec. 3, 2019.

(51) Int. Cl. A63B 27/00; E06C 1/34; E06C 1/38

(52) U.S. Cl. CPC A63B 27/00; E06C 1/381; E06C 1/34

(57) ABSTRACT

Tree-mountable climbing stick devices and methods of use are disclosed herein. A climbing stick can include a main strut having a first end, a second end, and an attachment member, a first attachment step located on the first end, the first attachment step comprising a first step and a first standoff that is configured to engage with a tree, a second attachment step located on the second end, the second attachment step comprising a second step and a second standoff that is configured to engage with the tree, and the first attachment step and the second attachment step each being configured to be rotated from a stored state to a deployed state.

### CROSS REFERENCE TO RELATED APPLICATION(S)

This non-provisional application claims the benefit and priority of U.S. Provisional Application Ser. No. 62/943,078, filed on Dec. 3, 2019, which is hereby incorporated by reference herein in its entirety, including all references and appendices cited therein, for all purposes, as if fully incorporated herein.

### FIELD OF TECHNOLOGY

The present disclosure is generally directed to climbing stick devices. A plurality of climbing stick devices can be used to create a segmented climbing apparatus, such as a ladder.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 is a perspective view of an example climbing stick of the present disclosure in association with a tree.

FIG. 2 is an exploded view of the example climbing stick of FIG. 1.

FIG. 3 is a perspective view of an example climbing stick with steps in a deployed state or configuration.

FIG. 4 is a side view of the example climbing stick with steps in a stored state or configuration.

FIG. 5 is a close up, perspective view of an attachment step assembly of the example climbing stick.

FIG. 6 is a cross section view of FIG. 5.

FIG. 7 illustrates two climbing sticks interconnected together.

### DETAILED DESCRIPTION

### Overview

The present disclosure pertains to devices that can be coupled to a tree and allow a user to climb the tree. These devices are generally referred to as tree-mountable climbing stick devices, or colloquially walking sticks or climbing sticks. More than one climbing stick can be connected together in series to form a ladder. An example climbing stick can include attachment steps that can be rotated from a stored to a deployed state. A user can carry a plurality of climbing sticks in a stacked configuration when the climbing sticks are each in a stored state.

A climbing stick of the present disclosure can include standoffs, which allow the climbing stick to engage with an outer surface of the tree. The standoffs can include teeth or other similar members that engage with, for example, the bark of the tree.

### EXAMPLE EMBODIMENTS

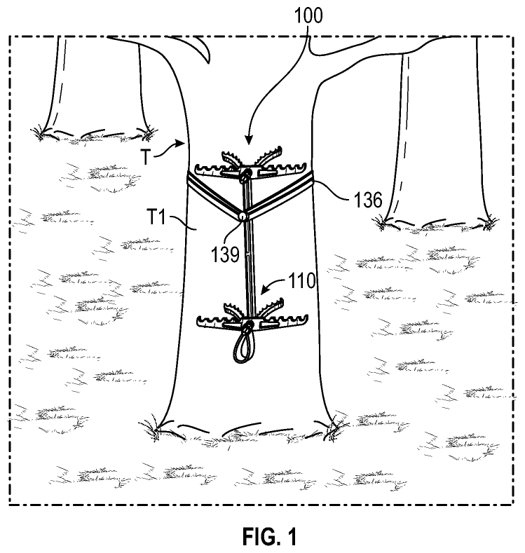

FIG. 1 is a perspective view of an example climbing stick 100 of the present disclosure in association with a tree T. The tree T includes a trunk T1 that has an outer surface OS. In some instances, the outer surface OS has bark disposed thereon. The climbing stick 100 can be secured to the trunk T1 using one or more tree straps such as tree strap 102. Connections between the climbing stick 100 and the trunk T1 are described in greater detail herein.

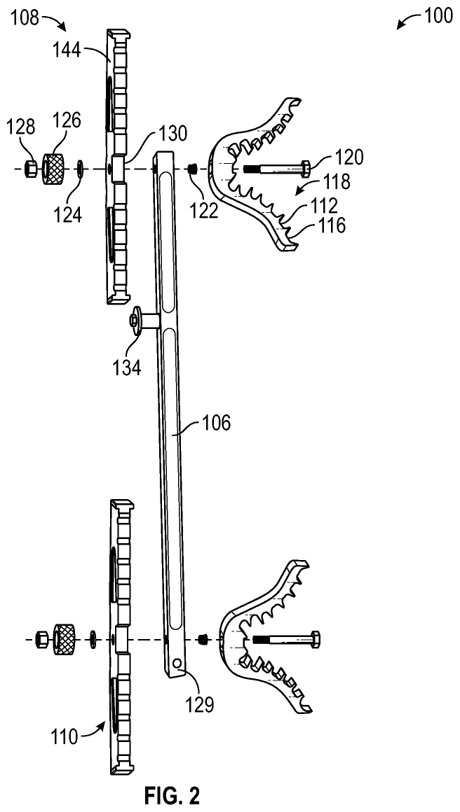

Referring now to FIG. 2, in general, a climbing stick 100 can comprise a main strut 106, a first attachment step 108, and a second attachment step 110. The first attachment step 108 can be constructed identically to one another in some instances. The first attachment step 108 can comprise a standoff 112 and a step 114. The standoff 112 engages with a trunk of the tree, as an example. Thus, the standoff 112 has legs, such as leg 116 that includes teeth 118 that engage with the trunk of the tree, such as the bark. The step 114 includes a patterned surface that provides a gripping surface for a shoe or boot of a user.

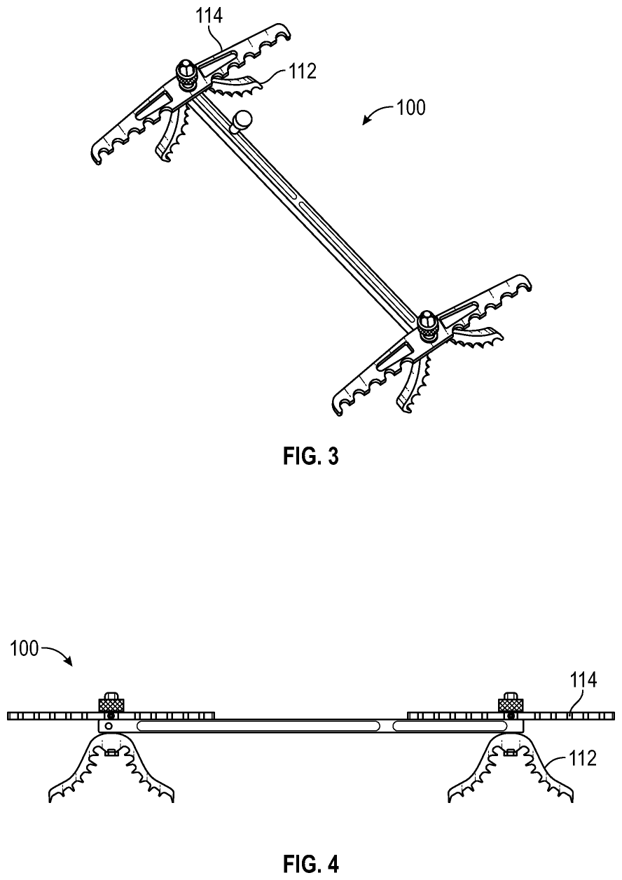

In some embodiments, the standoff 112 and the step 114 are rotatably coupled to an end of the main strut 106. For example, the standoff 112 and step 114 can be cooperatively coupled to the main strut 106 using a fastener 120, a spring 122, a washer 124, a knurled knob 126, and a nut 128. This fastening arrangement allows the standoff 112 and step 114 to rotate in synchronization with one another. For example, when the step 114 is rotated from a stored to a deployed position (see FIG. 3), the standoff 112 also rotates from the stored to a deployed position. In other embodiments, the standoff 112 and step 114 can rotate and be secured independently of one another.

The standoff 112 and step 114 are illustrated in a stored configuration, as with the climbing stick 100 illustrated in FIG. 4. When the first attachment step 108 is in the stored position the standoff 112 and step 114 are in a stored configuration. In the stored configuration, the standoff 112 and step 114 are aligned with the main strut 106. When in the deployed configuration, such as illustrated in FIG. 3, the standoff 112 and step 114 are substantially orthogonal or perpendicularly oriented related to the main strut 106.

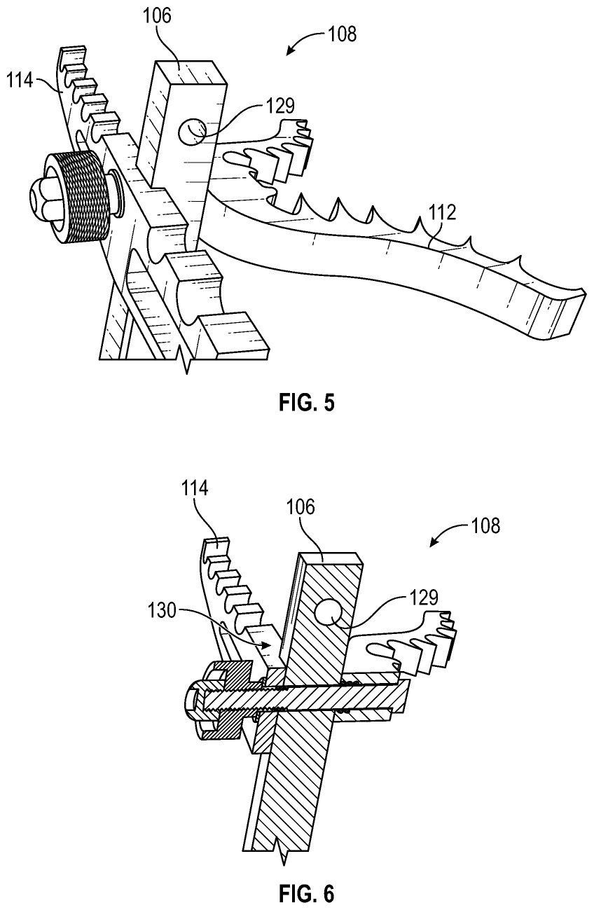

As best illustrated in FIGS. 5 and 6, when in the deployed configuration, a groove or slot 130 that is centrally located on the step 114 can overlap the main strut 106 to create a form fit between the step 114 and the main strut 106. When the fastening arrangement is locked, the step 114 is prevented from rotating, allowing the step 114 to bear the weight of a user without rotating. Thus, it will be understood that in FIGS. 2 and 4, the step 114 is illustrated in a laid-flat configuration, rather than. A close-up view of the first attachment step 108 is illustrated in FIG. 3.

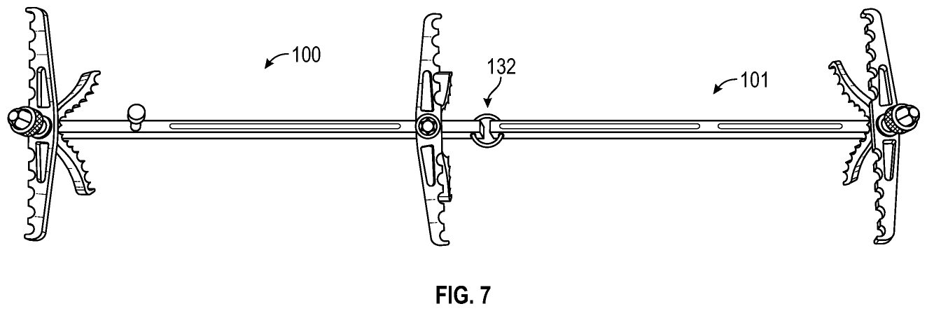

FIG. 3 also illustrates an attachment or anchor aperture 129 that receives a loop or strap 132 (see FIG. 7) that can be used to link two vertically adjacent climbing sticks as illustrated in FIG. 7 (climbing stick 100 and climbing stick 101). In some embodiments, the climbing stick 101 is a partial climbing stick. For example, a partial climbing stick can include only one attachment step on its lower or upper end.

Referring back to FIG. 1, a strap 140 can be used in combination with the climbing stick, in place of the partial climbing stick. The strap 140 can comprise a stirrup or other similar object (not shown) that allows a user to place their foot into for leverage. When two climbing sticks are spaced apart at a large distance, the strap 140 can be leveraged by a user as an intermediate step to bridge a gap between the two climbing sticks. The strap extends a distance below the climbing stick 100 so that the stirrup hangs below the second attachment step 110. The same stirrup could be connected to the anchor aperture 129 (see FIG. 6) as disclosed above.

Referring back to FIGS. 1 and 2, the climbing stick 100 can be attached to the tree T with a tree strap 136 that wraps around a trunk T1 of the tree T. The tree strap 136 can also affix to an attachment point 134 on the main strut 106. For example, one end of the tree strap 136 can couple to the attachment point 134. The tree strap 136 is wrapped around the tree and the second end of the tree strap 136 can be joined to the attachment point 134. The tree strap 136 can include a cinching mechanism to tighten the tree strap 136 and the climbing stick 100 to the tree. The cinching mechanism can include any strap or rope cinching mechanism that would be known to one of ordinary skill in the art.

The attachment point 134 can comprise a post 142 and a plate 144. The post 142 offsets the plate 144. A strap, such as the tree strap 136, can be wrapped or looped around the attachment point 134, with the plate 144 acting as a stop to prevent the strap from disassociating from the post 142.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “mechanically connected,” etc., are used interchangeably herein to generally refer to the condition of being mechanically/physically connected. It is further noted that various figures (including component diagrams) shown and discussed herein are for illustrative purpose only, and are not drawn to scale.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

Although the terms first, second, etc. may be used herein to describe various elements, components, regions, layers and/or sections, these elements, components, regions, layers and/or sections should not necessarily be limited by such terms. These terms are only used to distinguish one element, component, region, layer or section from another element, component, region, layer or section. Thus, a first element, component, region, layer or section discussed below could be termed a second element, component, region, layer or section without departing from the teachings of the present disclosure.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing and/or other any other types of manufacturing. For example, some manufacturing processes include three dimensional (3D) printing, laser cutting, computer numerical control (CNC) routing, milling, pressing, stamping, vacuum forming, hydroforming, injection molding, lithography and/or others.

Any and/or all elements, as disclosed herein, can include, whether partially and/or fully, a solid, including a metal, a mineral, a ceramic, an amorphous solid, such as glass, a glass ceramic, an organic solid, such as wood and/or a polymer, such as rubber, a composite material, a semiconductor, a nano-material, a biomaterial and/or any combinations thereof. Any and/or all elements, as disclosed herein, can include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, non-transparency, luminescence, anti-reflection and/or holographic, a photo-sensitive coating, an electronic and/or thermal property coating, such as for passivity, insulation, resistance or conduction, a magnetic coating, a water-resistant and/or waterproof coating, a scent coating and/or any combinations thereof.

Unless otherwise defined, all terms (including technical and scientific terms) used herein have the same meaning as commonly understood by one of ordinary skill in the art to which this disclosure belongs. The terms, such as those defined in commonly used dictionaries, should be interpreted as having a meaning that is consistent with their meaning in the context of the relevant art and should not be interpreted in an idealized and/or overly formal sense unless expressly so defined herein.

Furthermore, relative terms such as “below,” “lower,” “above,” and “upper” may be used herein to describe one element's relationship to another element as illustrated in the accompanying drawings. Such relative terms are intended to encompass different orientations of illustrated technologies in addition to the orientation depicted in the accompanying drawings. For example, if a device in the accompanying drawings is turned over, then the elements described as being on the “lower” side of other elements would then be oriented on “upper” sides of the other elements. Similarly, if the device in one of the figures is turned over, elements described as “below” or “beneath” other elements would then be oriented “above” the other elements. Therefore, the example terms “below” and “lower” can, therefore, encompass both an orientation of above and below.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A climbing stick, comprising:
a main strut having a first end, a second end, and an attachment member;
a first attachment step located on the first end, the first attachment step comprising a first step and a first standoff that is configured to engage with a tree;
a second attachment step located on the second end, the second attachment step comprising a second step and a second standoff that is configured to engage with the tree; and
wherein the first attachment step and the second attachment step are each configured to be rotated from a stored state to a deployed state.

2. The climbing stick according to claim 1, wherein the attachment member comprises a post and a plate, the attachment member being configured to receive and retain a loop or strap having stirrup on one end that hangs below the second end of the main strut.

3. The climbing stick according to claim 1, wherein the second end of the main strut comprises a means for coupling a loop or strap that is used to couple the climbing stick to a second climbing stick positioned below the climbing stick.

4. The climbing stick according to claim 1, wherein the first step comprises a channel that overlaps with and mates to the main strut when the first step is rotated into the deployed state.

5. The climbing stick according to claim 1, wherein the first attachment step is joined to the main strut using a fastening assembly, the fastening assembly comprising:
a fastening post that extends through the first step, the main strut, and the first standoff;
a resilient member positioned between the first standoff and the main strut; and
a knob positioned outside the first step and in threaded engagement with the fastening post such that rotation of the knob secures or releases the first step from the main strut.

7. The climbing stick according to claim 1, wherein the first standoff comprises flared arms that have internal surfaces with teeth.

6. A system, comprising:
a first climbing stick, comprising:
a main strut having a first end, a second end, and an attachment member;
a first attachment step located on the first end, the first attachment step comprising a first step and a first standoff that is configured to engage with a tree;
a second attachment step located on the second end, the second attachment step comprising a second step and a second standoff that is configured to engage with the tree, the second end further comprising an attachment point for a connector strap; and
wherein the first attachment step and the second attachment step are each configured to be rotated from a stored state to a deployed state; and
a second climbing stick that is identical to the first climbing stick, wherein the first climbing stick is connected to the second climbing stick by the connector strap.

7. The system according to claim 6, wherein the attachment member of the first climbing stick comprises a post and a plate, the attachment member being configured to receive and retain a loop or strap having stirrup on one end that hangs below the second end of the main strut.

8. The system according to claim 6, wherein the first step of the first climbing stick comprises a channel that mates with the main strut when the first step is rotated into the deployed state.

9. The system according to claim 6, wherein the first attachment step of the first climbing stick is joined to the main strut using a fastening assembly, the fastening assembly comprising:
a fastening post that extends through the first step, the main strut, and the first standoff;
a resilient member positioned between the first standoff and the main strut; and

10. The system according to claim 9, further comprising a knob positioned outside the first step and in threaded engagement with the fastening post such that rotation of the knob secures or releases the first step from the main strut.

11. A climbing stick, comprising:
a main strut having an attachment member;
two or more attachment steps located along the main strut, each of the two or more attachment steps having:
a step having a body comprising a channel;
a standoff, the standoff being configured to engage with a tree; and
a locking assembly comprising a fastening post and knob, the fastening post extending through the standoff and the step, the knob being associated with a terminal end of the fastening post, the step and the standoff being configured to rotate around the fastening post; and
wherein the step can be placed in a stored state and a deployed state, the main strut fitting within the channel of the step when the step is in the deployed state to prevent the step from rotating relative to the main strut, wherein the knob of the locking assembly is turned to lock the step in place and further prevent the step from rotating.

12. The climbing stick according to claim 11, wherein when locked the channel of the step and the main strut are mated to one another and sides of the main strut contact channel sides.

13. The climbing stick according to claim 11, further comprising a spring positioned between the standoff and the main strut.

14. The climbing stick according to claim 11, wherein the attachment member comprises a post and a plate, the attachment member being configured to receive and retain a loop or strap having stirrup on one end that hangs below the second end of the main strut.
